(19) United States
(12) Patent Application Publication
(10) Pub. No.: US 2006/0116475 A1
(43) Pub. Date: Jun. 1, 2006

(54) Shock-reinforced thermoplastic compositions comprising a ployamideand a block copolymer

(76) Inventors: Ludwik Leibler, Paris (FR); Francois Court, Paris (FR); Valery Rebizant, Luxembourg (FR); Volker Abertz, Bayreuth (DE); Francois-Genes Tournilhac, Paris (FR); Christophe Navarro, Lahonce (FR)

Correspondence Address: ARKEMA INC.;PATENT DEPARTMENT - 26TH FLOOR, 2000 MARKET STREET, PHILADELPHIA, PA, 19103-3222, US

(21) Appl. No.: 10/542,459

(22) PCT Filed: Jan. 13, 2004
(86) PCT No.: PCT/FR04/00048

§ 371 Date: Jul. 14, 2005

(30) Foreign Application Priority Data
Jan. 14, 2003 (FR) 03/00350

(51) Int. Cl. C08L 53/00

(52) U.S. Cl. 525/92 B

(57) ABSTRACT

The invention relates to a shock-reinforced thermoplastic composition comprising at least one polyamide and at least one block copolymer having a block that is entirely or mainly comprised of sydiotactic methyl polymethacrylate at a rate of more than 60%. The inventive composition has excellent mechanical properties and can be used in various applications.

This application claims benefit, under U.S.C. § 119 or §365 of French Application Number 03.00350, filed Jan. 14, 2003; and PCT/FR2004/000048 filed Jan. 13, 2004.

### FIELD OF THE INVENTION

The present invention relates to the field of impact-reinforced thermoplastic compositions, in particular to compositions based on polyamides reinforced with regard to impacts using a block copolymer.

The thermoplastic compositions of the invention are of use in all the fields of application of polyamides, particularly in fields requiring good thermomechanical behavior at low temperature and at high temperature, such as the automobile industry, the sports sector, electrical insulation and the protection of electrical or electronic equipment.

### BACKGROUND OF THE INVENTION

Many attempts have been made, since the beginning of the 1960s, to disclose polyamide, hereinafter denoted by PA, compositions having improved strength, which have resulted in numerous patents.

It has been shown that appropriate incorporation of a dispersed elastomer phase is effective in manufacturing extremely strong polyamides. The strategy consists in dispersing small particles in the thermoplastic matrix, which subsequently has to crystallize between the “walls” formed by these particles. This is what is referred to as crystallization in a confined geometry.

The impact reinforcing of brittle thermoplastics, such as polyamides, is well known. The main general methods used to modify thermoplastics in order to obtain an array of desired properties, such as the addition of functional/reactive polymers, in situ grafting or polymerization (reactive blending) and the addition of graft or block copolymers, are generally applicable to polyamides. An exception is the route consisting of the achievement of thermodynamic miscibility. Using this technique, vinyl polymers are in particular reinforced by addition of block copolymers comprising a poly(methyl methacrylate) (PMMA) block miscible with the thermoplastic matrix. This is because no polymer has shown sufficient miscibility with polyamides for this route to be applied.

Mention may be made, by way of indication, of FR 2 812 928, which discloses compositions based on PA reinforced with regard to impacts by the addition of an EPDM elastomer and of a polyethylene grafted with maleic anhydride.

Mention may also be made of studies carried out specifically with PMMA-based impact additives or impact additives comprising a PMMA-based block. This is because polyamides and copolymers comprising a PMMA block are immiscible. The solutions found in order to solve this problem are:

a system comprising three constituents, where the compatibilizing agent is miscible both with the polyamide and with the additive. This is the case, for example, with PA/PMMA blends compatibilized with poly(ether-block-amide)s (Pebax® from Atofina) based on poly(ethylene glycol) (PEG) (J. Mater. Sci., 1998, 33, 3729). The polyamide block of the Pebax is miscible with PA, while the PEG block exhibits favorable interactions with PMMA.

a system comprising three constituents, where the compatibilizing agent reacts with the end group of the PA and is miscible with the additive. This is the case with PA-6/PMMA blends compatibilized with styrene-maleic anhydride (SMA) polymers (Polymer, 1998, 39, 4985), PA-6/core-shell, with PMMA-based shell, blends compatibilized with SMAs and PA-6/core-shell, of polymer grafted with methyl methacrylate-styrene-butadiene (MBS) type, blends compatibilized with DGEBA- or phenoxy-based epoxide resins (Polymer, 1994, 35, 2764).

This method corresponds to that which Bonner and Hope (Blackie Acacdemic, Glasgow, 1993, 46) called “addition of functional/reactive polymers”.

system without compatibilizing agent, with simply reaction between the reactive polymer (the additive) and the PA (terminal amine). The reactive polymer can, for example, be a reactive core-shell (Polymer, 1993, 34, 1874).

This method corresponds both to “in situ grafting or polymerization” and to “the addition of grafted or block copolymers” according to Bonner and Hope.

The Applicant Company, seeking to develop polyamide-based thermoplastic compositions reinforced with regard to impacts by a simple and inexpensive means which is easy to implement and which does not require the addition of a compatibilizing agent, has found that some block copolymers, although immiscible with the polyamides, can effectively reinforce them.

This because the Applicant Company has found that blends based on a polyamide and on a block copolymer having at least one functionalized or nonfunctionalized PMMA block, syndiotactic to a level of greater than 60%, and at least one block with an elastomeric nature exhibit excellent thermomechanical properties although the constituents of the blends are completely immiscible.

The compositions of the invention exhibit excellent mechanical behavior at low temperature and at high temperature and introduce an effective solution to the problem set out above.

The interfacial adhesion between the PA and SBM triblock phases is certainly not unrelated to the spectacular reinforcing obtained.

It is certainly not ruled out, in the light of these results, that a reaction has taken place between one of the blocks of the SBM triblock and the terminal amine functional groups of the PA. The most probable reactions are those with the PMMA block, in the case of the ester groups having been hydrolyzed to acids or converted to anhydrides at the high processing temperature (set temperature of 250° C., resulting in a local material temperature of 260 to 290° C.), or optionally with the PB block, in the case of it not having been sufficiently stabilized. An even very low proportion of grafted molecules might have significant consequences for the interfacial adhesion.

### SUMMARY OF THE INVENTION

The first subject-matter of the invention is a thermoplastic composition comprising:

from 60 to 99% by weight of at least one polyamide (I)

from 1 to 40% by weight of at least one block copolymer (II).

The composition of the invention can additionally comprise up to 20% by weight of the total weight of the composition of an impact-reinforcing additive (III). The total contribution of (II) and (III) must not exceed 50% by weight of the total weight of the composition.

The composition of the invention additionally comprises all the additives necessary for its stability and for its processing, such as heat stabilizers, UV stabilizers, antioxidants, plasticizers, processing aids, antistatic agents, dyes and pigments.

The composition according to the invention can also comprise between 0 and 10% by weight of water.

According to a preferred form of the invention, the composition comprises

from 80 to 98% of (I)

from 2 to 30% of (II)

### BRIEF DESCRIPTION OF THE DRAWINGS

FIGS. 1-a and 1-b respectively show the curves of the dynamic storage modulus E′ and of tan δ as a function of the temperature (T) of the samples with the composition 80/20, compared with those of the pure PA-12ᵥ.

FIG. 2: Represents the change in the flexural modulus of various blends from Table 3, as a function of the level of impact modifier.

FIG. 3: Represents the Charpy impact curves for the various extruded blends of Table 4, compared with the extruded PA-12ᵥ.

FIG. 4: Is a correlation between the various properties (flexural modulus, MFI, impact strengths at −40, −20 and 23° C.) of the PA-12ᵥ/impact modifier 80/20 blends of Table 4.

### DETAILED DESCRIPTION OF THE INVENTION

As regards the polyamides, they have a number-average molecular mass \overline{Mn} generally of greater than or equal to 25 000 and advantageously of between 40 000 and 100 000. Their weight-average molecular mass \overline{Mw} is generally greater than 40 000 and advantageously between 50 000 and 100 000. Their intrinsic viscosity (measured at 20° C. for a sample of 5×10⁻³ g per cm³ of meta-cresol) is generally greater than 0.7.

Mention may be made, as examples of aliphatic polyamides resulting from the condensation of an aliphatic diamine having from 6 to 12 carbon atoms and of an aliphatic diacid having from 9 to 12 carbon atoms, of:

PA-6, 12, resulting from the condensation of hexamethylenediamine and of 1,12-dodecanedioic acid,

PA-9, 12, resulting from the condensation of C₉ diamine and of 1,12-dodecanedioic acid,

PA-10,10, resulting, from the condensation of C₁₀ diamine and of 1,10-decanedioic acid, up to 3000 ppm with respect to the amount of polyamide and advantageously between 50 and 1000 ppm.

It would not be departing from the scope of the invention to use a blend of polyamides.

Advantageously, the polyamide is chosen from the PA-6 polyamides from BASF known under the name Ultramid BS 700 or B4 and the PA-II and PA-12 polyamides from Atofina better known under Becno, Aecno or Aesno.

According to the invention, the block copolymer (II) corresponds to the following general formula:
Y-B-Y′

in which B is a block with an elastomeric nature and Y and Y′ may or may not be identical in chemical composition. They are thermodynamically incompatible with the B block.

The B block is an elastomer which can belong to the family of the polyolefins, polyacrylates, polyurethanes, polyethers, such as polyoxyethylene or polyoxypropylene, or nitrile elastomers. In particular, the monomer used to synthesize the elastomeric B block can be an alkene, such as isobutylene, a long-chain acrylate or methacrylate, such as butyl acrylate or 2-ethylhexyl acrylate, or a diene chosen from butadiene, isoprene, 2,3-dimethyl-1,3-butadiene, 1,3-pentadiene or 2-phenyl-1,3-butadiene. B is advantageously chosen from polydienes, in particular polybutadiene, polyisoprene and their random copolymers, or from partially or completely hydrogenated polydienes. Use is advantageously made, among polybutadienes, of those with the lowest glass transition temperature Tg, for example 1,4-polybutadiene with a Tg (approximately −90° C.) lower than that of 1,2-polybutadiene (approximately 0° C.). The B blocks can also be hydrogenated. This hydrogenation is carried out according to standard techniques. Preferably, the B blocks are predominantly composed of 1,4-polybutadiene.

Advantageously, the Tg of B is less than 0° C. and preferably less than −40° C. Y and Y′ can be obtained by the polymerization of at least one monomer chosen from the group consisting of styrene and short-chain methacrylates, such as methyl methacrylate. However, if Y is a block predominantly composed of styrene, then Y′ is other than a block predominantly composed of styrene.

Preferably. Y′, denoted below by M, is composed of methyl methacrylate monomers or comprises at least 50% by weight of methyl methacrylate, preferably at least 75% by weight of methyl methacrylate. The other monomers constituting this block may or may not be acrylic monomers and may or may not be reactive. Mention may be made, as nonlimiting examples of reactive functional groups, of: oxirane functional groups, amine functional groups, anhydride functional groups or carboxylic acid functional groups. The reactive monomer can be a hydrolyzable monomer resulting in acids. Mention may be made, among the other monomers which can constitute the Y′ block, as nonlimiting examples, of glycidyl methacrylate or tert-butyl methacrylate.

Advantageously, M is composed of poly(methyl methacrylate) (PMMA) syndiotactic to at least 60%.

When Y is different in chemical composition from Y′, as in the case of the examples below, Y is denoted by S. This block can be obtained by the polymerization of vinylaromatic compounds, such as, for example, styrene, α-methylstyrene, vinyltoluene or vinylpyridines. The Tg of Y (or S) is advantageously greater than 23° C. and preferably greater than 50° C.

The triblock copolymer, Y-B-Y′, according to the invention is subsequently denoted by S-B-M.

According to the invention, the S-B-M has a number-average molar mass which can be between 10 000 g/mol and 500 000 g/mol, preferably between 20 000 and 200 000 g/mol. The SBM triblock advantageously has the following composition, expressed as fraction by weight, the total being 100%:

M: between 10 and 80% and preferably between 15 and 70%,

B: between 2 and 80% and preferably between 5 and 70%,

S: between 10 and 88% and preferably between 5 and 85%.

According to the invention, the SBM can comprise at least one S-B diblock in which the S and B blocks have the same properties as the S and B blocks of the S-B-M triblock. They are composed of the same monomers and optionally comonomers as the S blocks and the B blocks of the S-B-M triblock.

The S-B diblock has a number-average molar mass which can be between 5000 g/mol and 500 000 g/mol, preferably between 10 000 and 200 000 g/mol. The S-B diblock is advantageously composed of a fraction of B by weight of between 5 and 95% and preferably between 15 and 85%.

The blend of S-B diblock and of S-B-M triblock is denoted below by SBM. This blend advantageously comprises between 5 and 80% of S-B diblock for respectively from 95 to 20% of S-B-M triblock.

One advantage of these SBM block compositions is that it is not necessary to purify the S-B-M at the end of its synthesis. In other words, the component (II) according to the present invention can very well be a blend of S-B diblocks and of S-B-M triblocks.

As regards the compound (III), it is chosen from impact additives and elastomers. These products are known per se. For example, they are described in Ullman's Encyclopedia of Industrial Chemistry 5th edition, Vol. A 23, pages 255-261, the content being incorporated in the present application. The preferred additives are those described in the examples.

When the SBMs carry reactive functional groups, the latter are preferably carried by the M block and introduced at a level of 20 mol % with respect to M.

The composition of the invention can be used as is in the preparation of objects by injection molding, extrusion, blowing or molding.

The composition according to the invention can also be used as constituent of composite materials in combination with glass fibers, carbon fibers or other fibers derived from carbon, metal fibers or textile fibers. It can also be used in the preparation of polymer alloys, such as polyamide/polyolefin alloys (orgalloy).

The following examples illustrate the invention without limiting the scope thereof.

### EXAMPLES

Compounds

The following products are used in the examples:
Polyamide: polyamide 12 from Atofina (PA-12ᵥ)
   Mₙ=24.4 kg/mol M_{w}/Mₙ=2.35
   Amine number=0.028±0.003 meq/g

The weight distribution is determined by gel permeation chromatography on a high temperature GPC device of the Waters 150-C ALC/GPC type with benzyl alcohol at 130° C. as eluent. Prior to the measurement, the polyamide is dissolved at 130° C. for 4 hours.

The ends of NH₂ chains are quantitatively determined by potentiometry. The sample is dissolved in m-cresol under hot conditions (120° C.). The potentiometric determination is carried out on a Pot DL40 device at 60° C. The standard deviation is calculated with regard to 2 measurements.
LOTADER4700 (Atofina): contains 29.5±3.0% of ethylacrylate and 1.3±0.2% of maleic anydride, the remainder being polyethylene (PE)
   Mₙ=1.62 kg/mol
   M_{w}/Mₙ=5.8
   MFI=6 to 8 g/10 min
   1 to 2% of crystallinity (DSC)
   synthesized by radical polymerization at high pressure.
EPRm EXXELOR™ VA 1801 (Exxon): ethylene/propylene ratio 70/30
   0.7% of maleic anhydride by weight
   MFI (230° C., 10 kg)=9 g/l 0 inn
   Tg=−42° C. (DSC).
SBM-00.17Composition S/B/M: 32.4/361/31.6
   Mₙ(PS)=21.9 kg/mol
   M_{w}/Mₙ(PS)=1.5
   3% PS in SB
   31% SB in SBM.
SB[MA]-237: S₃₄B₃₁[M₃₄A₁]
   Mₙ(PS)=23.3 kg/mol
   M_{w}/Mₙ(PS)=1.17
   3% PS in SB
   28% SB in SBM.
      Processing and Composition of the Blends:

The products used are in the form of granules. The block copolymer SB[MA]-237, initially in the form of lumps resulting from their precipitation subsequent to the synthesis, was thus melted at 150° C. on a Lescuyer two-roll calender and then granulated. The products are stoved under vacuum at 80° C. for 8 hours.

The blends were prepared on a Werner 30 corotating extruder with the screw profile 52A3, a flat temperature profile at 250° C., a flow rate of 10 kg/h and a rotational speed of the screws of 300 rpm, find then granulated.

The compositions of the blends prepared are summarized in Table 1. Examples 1 to 5 are control examples outside the invention. Examples 6 to 8 are examples according to the invention.

TABLE 1
Compositions of the blends prepared

| Products | 1 | 2 | 3 | 4 | 5 | 6 | 7 | 8 |
|---|---|---|---|---|---|---|---|---|
| PA-12_{ν} | 100 | 90 | 80 | 90 | 80 | 90 | 80 | 80 |
| LOTADER 4700 | | 10 | 20 | | | | | |
| EPRm VA1801 | | | | 10 | 20 | | | |
| SBM-00.17 | | | | | | 10 | 20 | |
| SB[MA]-237 | | | | | | | | 20 |

Characterization Tests and Results:
Preparation of the Test Specimens for the 3-Point Bending and Charpy Impact Measurements

The various experimental conditions for the preparation of the bars subsequently used for the 3-point bending and Charpy impact measurements are described below:

Bars with dimensions of 80×10×4 mm³ are obtained by injection of the granules into a Battenfeld 800 CDC press. The rotational speed of the screws is 130 rpm and the injection temperatures are 250/270° C.

3-Point Flexural Modulus

The measurements of the 3-point flexural modulus (standard ISO 178:93) of the test specimens described above are carried out at 23° C. on a Zwick 1465 robotic universal testing device. The test rate is 2 n/min, with a displacement sensor extensometer, a 1000 N measuring cell and a span of 64 mm.

Charpy Impact (Notched Test Specimens)

The test specimens described above are notched in packs of 20 using a Notch Vis device from Ceast in order to have a depth undernotch of 8 mill. They are subsequently conditioned for at least 18 hours in a room regulated at 23° C. and with a humidity of 50%, before being placed for at least 30 minutes at the temperature of the desired test, that is to say 23, 0, −10, −20, −30 or −40° C.

For all the examples, the Charpy impact measurements are carried out in accordance with standard ISO 179-1/1eA on a digital Zwick Z 5102 impact testing device equipped with pendulums with respective energies of 1, 2 and 4 J (standardized, speed 2.9 m/s). The energy, corrected for friction, E, absorbed by the pendulum during the impact is directly related to the impact strength IS by the relationship:

$$IS = \frac{E}{t \cdot w} ,$$

where t is the thickness of the test specimen and w is the width under notch.
Dynamic Mechanical Analysis (DMA)

The DMA measurements were carried out on a DMA 2980 device loom TA Instruments. The samples used are impact half-bars with dimensions of 40×10×4 mm³. The double cantilever bending, clamp is used in the single cantilever bending mode, with a working length between the clamps of 18 mm. All the measurements were carried out at a frequency of 1.6 Hz and with an oscillation amplitude of 40 μm. Measurement points were recorded from −140 to 180° C. with heating in stationary phases with an increment of 3° C. The loss and dynamic storage moduli. E″ and E′, and the tangent of the phase angle tan δ=E″/E′ of the samples are measured.

RESULTS

DMA Results

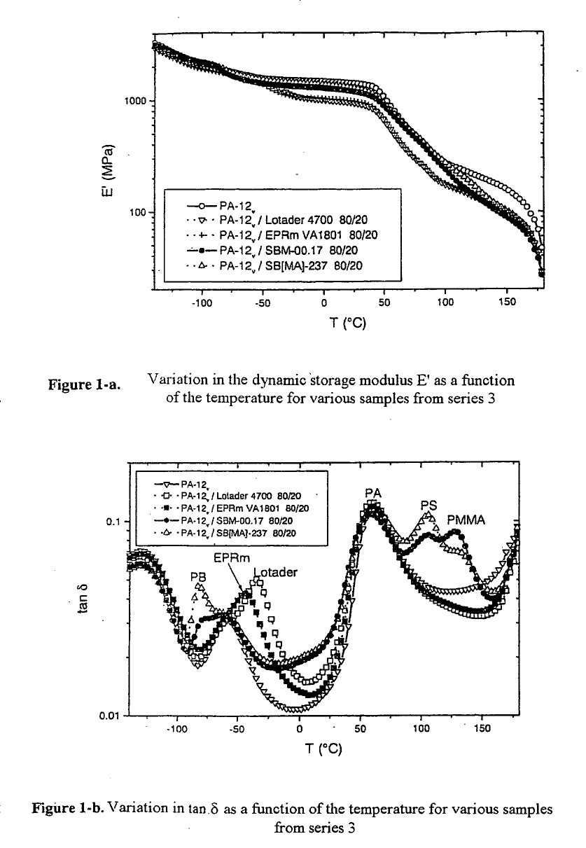

FIGS. 1-a and 1-b respectively show the curves of the dynamic storage modulus E′ and of tan δ as a function of the temperature (T) of the samples with the composition 80/20, compared with those of the pure PA-12ᵥ.

The glass transition temperatures, determined by DMA, are summarized in Table 2.

TABLE 2
T_{g} (° C.) determined by DMA (tan δ curves)

| | PB | EPRm | LOTADER | PA | PS | PMMA |
|---|---|---|---|---|---|---|
| PA-12_{ν}(example 1) | — | — | — | 61 | — | — |
| PA-12_{ν}/Lotader 4700 | — | — | −35 | 61 | — | — |
| 80/20 (example 3) | | | | | | |
| PA-12_{ν}/EPRm VA1801 | — | −44 | — | 61 | — | — |
| 80/20 (example 5) | | | | | | |
| PA-12_{ν}/SBM-00.17 | −83 | — | — | 61 | 106 | 130 |
| 80/20 (example 7) | | | | | | |
| PA-12_{ν}/SB[MA]-237 | −77 | — | — | 58 | 106 | 127 |
| 80/20 (example 8) | | | | | | |

It Should be noted first of all that the peak observed at −60° C. on the tan δ curves corresponds to the β transition of the PA-12ᵥ.

As the level of PMMA in the block copolymer SB[MA]-237 is low, its glass transition temperature cannot be observed by DMA.

There is no significant difference in the T_{g} value of the PA in the blends with respect to the pure PA and of the various constituents of the block copolymers between the blends concerned. This indicates that there is no miscibility between any of the constituents under consideration.

The modulus at 23° C. of the PA modified with 20% of SBM or of SB[MA] is slightly lower than that of the pure PA, whereas the moduli of the standards are markedly reduced. At 90° C. the value of the modulus of the PA modified with 20% of SBM or of SB[MA], until then close to that of the pure PA, falls to reach, at approximately 130° C. that of the standards with 20% of LOTADER or of maleicized EPR. This phenomenon occurs when the temperature reaches the T_{g} values of the PS and of the PMMA, illustrating the advantage of the stiff SBM phases.

3-Point Flexural Modulus

The 3-point flexural moduli at 23° C. and the MFI values (235° C., 2.16 kg) of samples of PS-12ᵥ extruded alone and of extruded blends of PA-12ᵥ with 10 or 20% of impact modifier are presented in Table 3.

TABLE 3
3-Point flexural modulus at 23° C.

| | 3-Point flexural modulus | MFI |
|---|---|---|
| | (MPa) | (g/10 min) |
| PA-12_{ν}(example 1) | 1283 ± 8 | 2.4 ± 0.1 |
| PA-12_{ν}/LOTADER 4700 | 1086 ± 71 | 1.1 |
| 90/10 (example 2) | | |
| PA-12_{ν}/LOTADER 4700 | 861 ± 66 | 0.5 |
| 80/20 (example 3) | | |
| PA-12_{ν}/EPRm VA1801 | 1083 ± 21 | 1.3 |
| 90/10 (example 4) | | |
| PA-12_{ν}/EPRm VA1801 | 896 ± 18 | 0.6 |
| 80/20 (example 5) | | |
| PA-12_{ν}/SBM-00.17 | 1237 ± 40 | 1.4 |
| 90/10 (example 6) | | |
| PA-12_{ν}/SBM-00.17 | 1173 ± 7 | 0.4 |
| 80/20 (example 7) | | |
| PA-12_{ν}/SB[MA]-237 | 1233 ± 10 | 0.3 |
| 80/20 (example 8) | | |

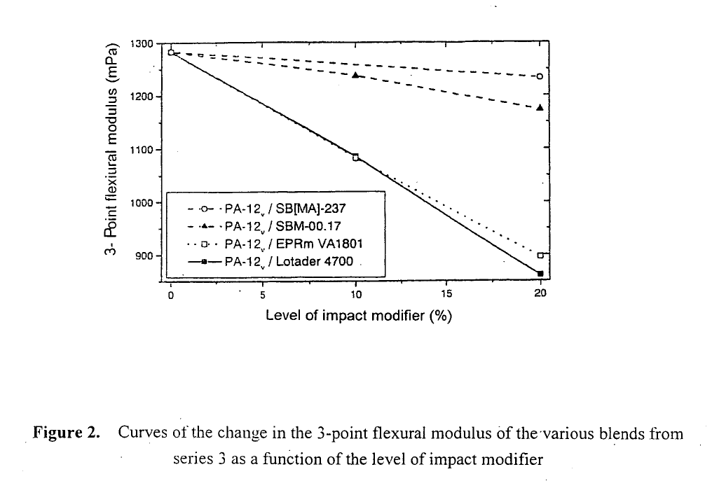

The change in the flexural modulus of these various blends as a function of the level of impact modifier is represented in FIG. 2.

It should be noted first of all that the measurements of the flexural modulus are in agreement with the measurements of the modulus at 23° C. by DMA.

The reactive product SB[MA] gives the highest flexural modulus of the impact modifiers at 20% in the PA-12ᵥ. While the standard blends result in a very marked virtually linear reduction in the flexural modulus with respect to the pure PA with the increase in the level of impact modifier (fall of 300% for 20% of impact modifier), the addition of block copolymers to the PA results in only a small reduction in the flexural modulus (less than 9% for 20% of block copolymers), whether or not they are reactive.

Properties of Resistance to the Notched Charpy Impact

There are four types of failure following an impact:

C=Complete break: break in which the test specimen separates into at least two pieces.

H=Hinge break: incomplete break such that the two parts of the test specimen hold together only via a thin peripheral layer with the shape of a hinge having a low residual stiffness.

P=Partial break: incomplete break which does not correspond to the definition of the hinge break.

N=Non-break: in the case where there is no break, the test specimen is only bent and is driven between the supports, with possible whitening due to the stress.

The Charpy impact properties of samples of PA-12ᵥ extruded alone and of extruded blends of PA-12ᵥ with 10 or 20% of impact modifier are presented in Table 4.

TABLE 4
Charpy impact properties of the samples from series 3

| | 23° C. | 0° C. | −10° C. | −20° C. | −30° C. | −40° C. |
|---|---|---|---|---|---|---|
| PA-12_{ν}(example 1) | 11.1 ± 0.8 | 8.6 ± 0.3 | | 7.4 ± 0.2 | | 7.7 ± 0.2 |
| | (C) | (C) | | (C) | | (C) |
| PA-12_{ν}/Lotader 4700 | 37 ± 5 | 24 ± 4 | 22 ± 3 | 17 ± 2 | 14.0 ± 0.9 | 11.2 ± 0.9 |
| 90/10 (example 2) | (P/H) | (C) | (C) | (C) | (C) | (C) |
| PA-12_{ν}/Lotader 4700 | 73 ± 12 | 79 ± 3 | 54 ± 5 | 29 ± 1 | 18 ± 2 | 13.5 ± 0.2 |
| 80/20 (example 3) | (P) | (P) | (P/H) | (H/C 4/1) | (C) | (C) |
| PA-12_{ν}/EPRm VA1801 | 53 ± 10 | 37 ± 8 | 38 ± 5 | 24 ± 5 | 27 ± 9 | 12.7 ± 0.5 |
| 90/10 (example 4) | (P) | (H) | (C) | (C) | (C) | (C) |
| PA-12_{ν}/EPRm VA1801 | 60 ± 11 | 50 ± 4 | 55 ± 6 | 47 ± 10 | 28 ± 4 | 24 ± 4 |
| 80/20 (example 5) | (P) | (P) | (P/H) | (P/H) | (C) | (C) |
| PA-12_{ν}/SBM-00.17 | 80 ± 2 | 22 ± 1 | 21.0 ± 0.8 | 20.2 ± 0.5 | 20.4 ± 0.7 | 19.5 ± 0.7 |
| 90/10 (example 6) | (P) | (C) | (C) | (C) | (C) | (C) |
| PA-12_{ν}/SBM-00.17 | 110 ± 3 | 103 ± 1 | 99 ± 4 | 95 ± 3 | 85 ± 2 | 37 ± 1 |
| 80/20 (example 7) | (P) | (P) | (P) | (P) | (P) | (C) |
| PA-12_{ν}/SB[MA]-237 | 53 ± 2 | 63 ± 1 | 60 ± 2 | 52 ± 1 | 23 ± 2 | 22.7 ± 0.7 |
| 80/20 (example 8) | (P) | (P) | (P) | (P) | (C) | (C) |

Value of the impact strength in kJ/m² (the type of break between brackets)
Mean and standard deviation with regard to 10 measurement at 23 and −40° C. and with regard to 5 measurements at 0, −10, −20 and −30° C.

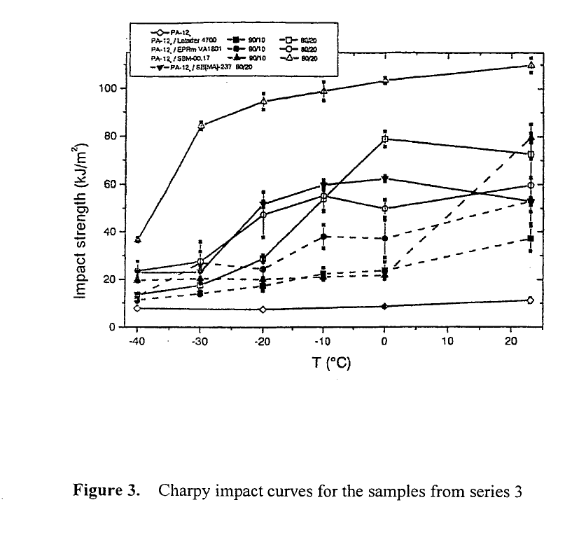

The Charpy impact curves for these various extruded blends, compared with the extruded PA-12ᵥ, are represented in FIG. 3.

It should be noted first of all that the standard deviations are much smaller for the blends with SBM and SB[MA] than for those with Lotader and EPRm.

The copolymer SBM results in by far the best reinforcing at 20% in the PA-12ᵥ, with a ductile-brittle transition between −40 and −30° C., and the highest values for impact strength of the series over the entire range of temperatures studied (between −40 and 23° C.).

At 10% of SBM in the PA, the ductile-brittle transition temperature lies between 0 and 23° C., with a value for impact strength at 23° C. comparable to that with 20% of Lotader and better than that with 20% of EPRm.

The reactive product SB[MA] at 20% in the PA-12, is equivalent to 20% of EPRm over the entire range of temperatures, with a ductile-brittle transition between −30 and −20° C.

The TEM images of the 80/20 PA-12ᵥ/Lotader 4700 and PA-12ᵥ/EPRm VA1801 blends stained with phosphotungstic acid and PA-12ᵥ/SB[MA]-237 and PA-12ᵥ/SBM-00.17 blends stained with OsO₄ are given in FIGS. V-6a-d. The particles of Lotader 4700. EPRm VA1801 and SB[MA]-237 in the polyamide matrix do not exceed 400 nm, whereas the particles of SBM-00.17 range as far as reaching 1.6 μm.

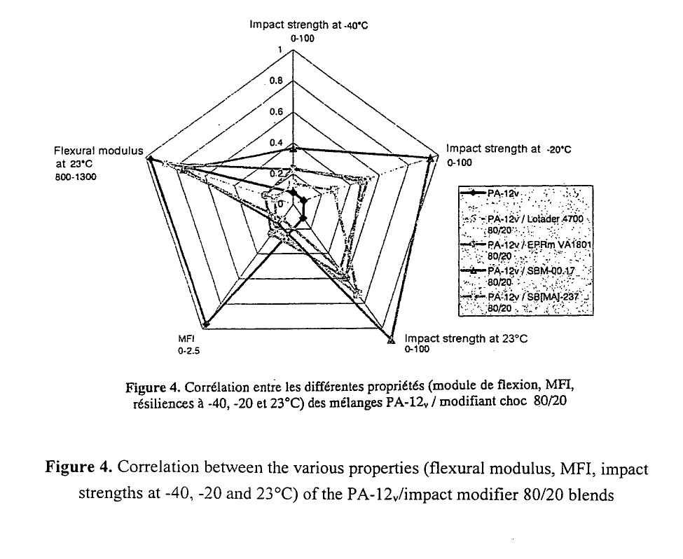

The blend with the block copolymer SBM obtained at 260-290° C. offers by far the best impact strength and the best “impact/modulus/melt flow” compromise (FIG. 4).

1. A thermoplastic impact-reinforced polyamide composition comprising:
I) from 60 to 99% by weight of the total weight of the composition of at least one polyamide (I);
II) from 1 to 40% by weight of the total weight of the composition of at least one block copolymer (II) corresponding to the following general formula Y-B-Y′ wherein:
B is an elastomeric block thermodynamically incompatible with the Y and Y′ blocks,
Y and Y′ are the same or different,
at least one of the two blocks Y and Y′ being partially or entirely composed of poly(methyl methacrylate); and
III) from 0 to 20% by weight of the total weight of the composition of at least one impact additive,
the total of (II) and (III) not exceeding 50% by weight.

2. The composition as claimed in claim 1, comprising:
from 70 to 98% by weight of (I)
from 2 to 30% by weight of (II).

3. The composition as claimed in claim 1, wherein B comprises at least one monomer unit selected from the group consisting of butadiene, isoprene, 2,3-dimethyl-1,3-butadiene, 1,3-pentadiene and 2-phenyl-1,3-butadiene.

4. The composition as claimed in claim 3, wherein B comprises butadiene.

5. The composition of claim 1, wherein Y and Y′ comprise at least one monomer unit chosen from styrene and short-chain alkyl methacrylates.

6. The composition as claimed in claim 5, wherein Y is a block composed predominantly of styrene and wherein Y′ is a block composed predominantly of methyl methacrylate syndiotactic to a level of greater than 60%.

7. The composition as claimed in claim 1, wherein the impact additive comprises an elasomer.

8. The composition of claim 1, wherein the polyamide (I) is at least one polyamide selected from the group consisting of polyamides -4, -6, -10, -11, -12, -4,6, -6,9, -6, 10, -6,12 and -12,12.

9. A polyphase composite material comprising the composition of claim 1 and at least one fiber compound selected from the group consisting of glass fibers, carbon fibers, fibers derived from carbon, metal fibers, and textile fibers.

10. A polymer alloy comprising the composition of claim 1 and at least one compound selected from the group consisting of polyamides and polyolefins.

11. A thermoplastic object comprising the composition of claim 1, formed by injection molding, extrusion, blowing or molding.

12. (canceled)

13. (canceled)

14. (canceled)

15. The composition of claim 5, wherein Y and Y′ comprise methyl methacrylate.

16. The composition as claimed in claim 7, wherein the impact additive elastomer comprises EPDM or elastomeric polyolefins.
